(19) United States
(12) Patent Application Publication
(10) Pub. No.: US 2017/0155892 A1
(43) Pub. Date: Jun. 1, 2017

(54) WEARABLE STEREOSCOPIC CAMERA SYSTEM FOR 3D VIRTUAL REALITY IMAGING AND NETWORKED AREA LEARNING

(71) Applicants: BRIAN HERRERA, TUCSON, AZ (US); TY WOOD - PAVICICH, TUCSON, AZ (US); LELAND STANFORD SEDBERRY, IV, TUCSON, AZ (US)

(72) Inventors: BRIAN HERRERA, TUCSON, AZ (US); TY WOOD - PAVICICH, TUCSON, AZ (US); LELAND STANFORD SEDBERRY, IV, TUCSON, AZ (US)

(21) Appl. No.: 15/362,093

(22) Filed: Nov. 28, 2016

Related U.S. Application Data
(60) Provisional application No. 62/260,497, filed on Nov. 28, 2015.

(51) Int. Cl. H04N 13/04; H04R 5/027; G06F 3/01; H04N 13/02; G06T 7/70

(52) U.S. Cl. CPC H04N 13/044; H04N 13/0239; G06T 7/70; G06F 3/017; H04R 5/027; H04R 2499/15

(57) ABSTRACT

A pair of smart-glasses has a frame. A pair of camera units is positioned on a front area of the frame and separated laterally a distance comparable to that of adult human eyes. A binaural microphone system is coupled to the frame to mimic human ears. Inertial measurement units are coupled to the frame that simulate the human vestibular system.

### RELATED APPLICATIONS

The present patent application claims the benefit of U.S. Provisional Application No. 62/260,497, filed Nov. 28, 2015, entitled “WEARABLE STEREOSCOPIC CAMERA SYSTEM FOR 3D VIRTUAL REALITY IMAGING”, and which is incorporated herein by reference in its entirety.

### TECHNICAL FIELD

The present invention relates generally to a 3D imaging system for virtual and augmented reality applications, and, more specifically, to a distributed network of smart-glasses that collect stereoscopic images, binaural sound, and inertial motion data to compute spatial information about the user's surroundings in order to enhance the presentation of the recorded 3D content in Virtual or Augmented Reality.

### BACKGROUND

Stereoscopic video combined with surround audio recording mechanisms have been used to create 3D visual and audible renditions of an environment. U.S. Pat. No. 9,191,645demonstrates a method and apparatus for recording, encoding, and displaying 3D videos accompanied by surround sound audio.

Head mounted camera systems have been used to gather first person perspective images. U.S. Pat. No. 7,542,665 describes a device that employs two eye tracking cameras to determine the orientation of the user's pupils which is used to redirect the direction that a head mounted camera or cameras are facing.

However, none of the above disclose the ability to form a distributed network of smart-glasses. None of the above prior art references disclose a distributed network of smart-glasses that is able to collect high-definition stereoscopic images, binaural audio, and spatial orientation information in order to render pictures and videos that appear in 3D when viewed in a virtual reality, augmented reality, or any other type of immersive digital environment.

Therefore, it would be desirable to provide a system and method that overcomes the above. The system and method would provide for a distributed network of smart-glasses that is able to collect high-definition stereoscopic images, binaural audio, and spatial orientation information in order to render pictures and videos that appear in 3D when viewed in a virtual reality, augmented reality, or any other type of immersive digital environment.

### SUMMARY OF THE INVENTION

The present invention comprises a method and apparatus for deploying a distributed network of smart-glasses that collect high-definition stereoscopic images, binaural audio, and spatial orientation information in order to render pictures and videos that appear in 3D when viewed in a virtual reality, augmented reality, or other type of immersive digital environment.

The present implementation of the invention employs two identical camera units separated laterally a distance comparable to that of adult human eyes; a binaural microphone system to mimic human ears; and inertial measurement units that simulate the human vestibular system.

In one implementation of the invention, neural network algorithms process stereoscopic image data and inertial motion data in conjunction with one another to dynamically compute three-dimensional spatial information of the user's surroundings.

In one implementation of the present invention proposed, the smart-glasses device is powered by an on-board power source and emits and receives wireless signals in order to be networked to other computing devices. In many implementations of the invention it may be controlled wirelessly from tethered devices such as smartphones or smart-watches, manually through buttons or tactile sensors, computationally by processing user gestures detected by the imaging components, or by acting on its own accord.

In one embodiment of the invention, the smart-glasses use information from the available data inputs and user interactions to increase the utility of each device as a social photography device. Such processes grant users the ability to create 360-degree, spherical photos in 3D; detect if recorded content would cause a viewer to feel motion sickness; or automatically capture data and send it to the cloud where it may be indexed in order to be accessed and displayed through another device that renders images in virtual reality. Other than providing these features to users enhancing the ability to create and share virtual reality images in an expressive and communicative way, the data collected by each unit can be processed either on the device, a tethered computing unit, or within some web or cloud based infrastructure. One such embodiment of the invention may be used to reconstruct volumetric 3D renditions of objects or locations, achieve spatial awareness similar to the way the human brain does, and sense depth in order to augment three-dimensional digital objects into the stereoscopic image. These abilities are important aspects of one embodiment of the invention in which the imaging and sensing device is integrated with a heads-up augmented reality display.

Any and all such implementations of the invention are qualitatively and quantitatively enhanced through the networking of independent devices collectively acquiring 3D spatial information to understand the space that they coexist within.

### BRIEF DESCRIPTION OF THE DRAWINGS

The present application is further detailed with respect to the following drawings. These figures are not intended to limit the scope of the present invention but rather illustrate certain attributes thereof

FIGS. 1A-1D show multiple views of an example implementation of the present invention that employs a stereoscopic imaging system and a binaural recording system in accordance with one embodiment of the present invention;

FIG. 2 shows the imaging capabilities of an example implementation of the invention compared to that of the human eye in accordance with one embodiment of the present invention;

FIGS. 3A-3B shows an example of how two different embodiments of the present invention are worn by a user in accordance with embodiments of the present invention;

FIG. 3C show an example of an output of the cameras in accordance with one embodiment of the present invention;

FIG. 4A-4B shows an example of how a user may control the invention using programmable gesture controls and a passive, frame buffer in accordance with one embodiment of the present invention;

FIG. 5 shows a block diagram of the control mechanism and electronic components of one implementation of the present invention;

FIG. 6 shows the manner in which the digital content generated by an embodiment of the invention is displayed to a user by means of a Virtual Reality Headset in accordance with one embodiment of the present invention;

FIG. 7 shows an implementation of the present invention in which an inertial measurement unit is used to achieve spatial awareness and enhance the photographic capability of the device in accordance with one embodiment of the present invention;

FIG. 8A-8D shows implementations of the invention and trained user interaction that enables the capture and display of 3D, spherical, panoramic images with fields of view spanning larger regions than the embedded camera lenses in accordance with one embodiment of the present invention;

FIG. 9A-9B shows implementations of the invention in which images passively collected by the device in use are aggregated and used to compose 3D renditions of objects and locations in accordance with one embodiment of the present invention; and

FIG. 10 shows one implementation of the invention in which the collected data is used to sense depth in order to augment a digital object within a virtual reality image or an augmented reality, heads-up display in accordance with one embodiment of the present invention.

### DETAILED DESCRIPTION AND BEST MODE OF IMPLEMENTATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

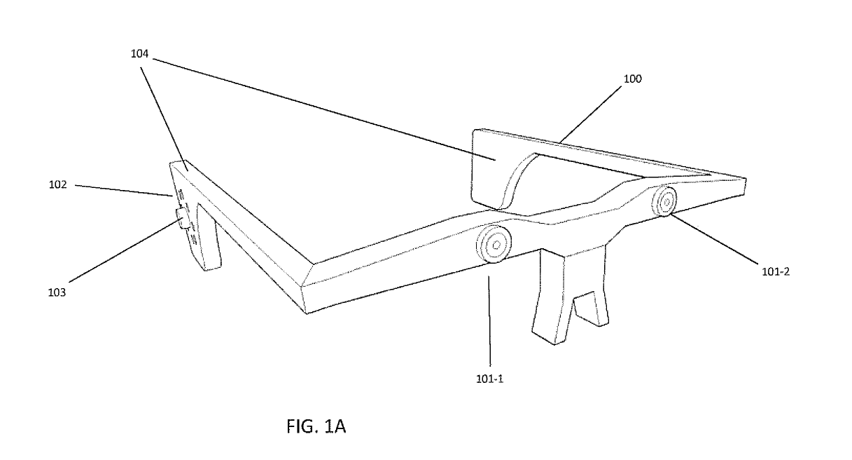

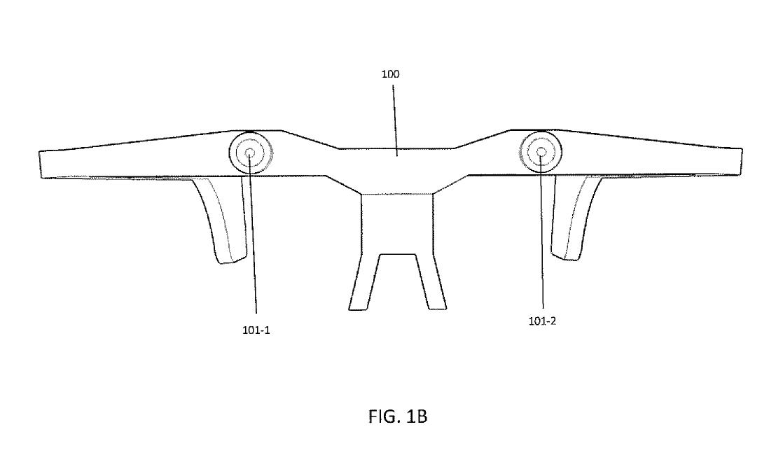

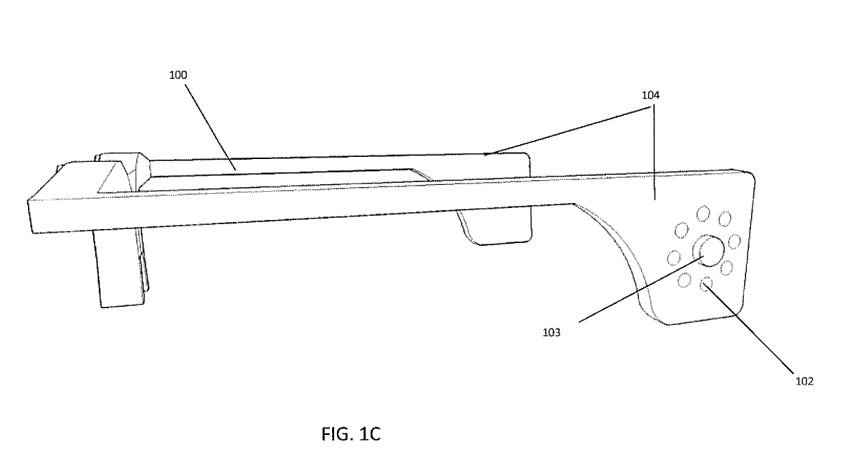

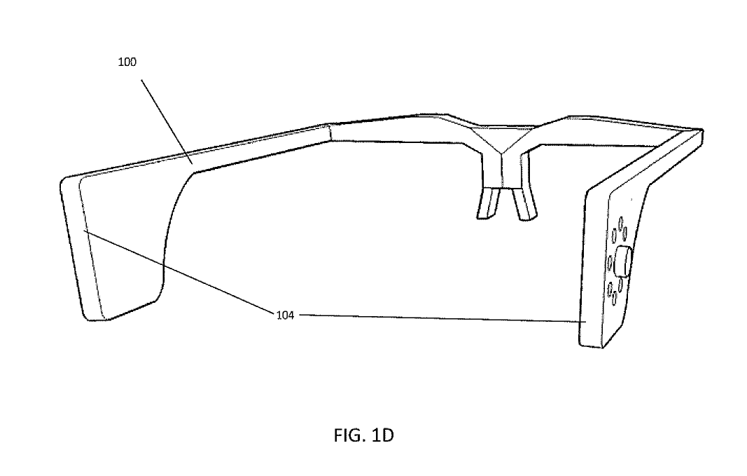

As shown in FIGS. 1A-1D, different views of the apparatus according to an example implementation of the present invention contains a stereoscopic imaging system, binaural audio recording system, and inertial measurement system all contained within a single wearable device. FIG. 1 A shows a top-right diagonal view of the entire wearable device 100 of the present invention. The frontal view in FIG. 1B demonstrates the arrangement of the two components of the stereoscopic imaging system 101 positioned such that the distance between the two individual optical axes is similar to the average human interocular distance. In other implementations of the invention, any plurality of cameras and sensors may be otherwise oriented for additional capabilities in detecting spatial information. The side view in FIG. 1C demonstrates one possible embodiment of microphone receivers 103 on the right side of wearable device 100, an arrangement that is also mirrored on the left side. In this implementation of the invention, a microphone 103 is placed near each ear and the audio data is processed such that the human perception of sound is simulated upon playback. In other implementations of the invention, any plurality of microphones can be otherwise oriented and the recorded sound data is accordingly processed. In any implementation of the invention, the microphones 103 may be used as an input to a processing unit either within the processing unit, or any co-networked computing device that interprets voice commands. Additionally, a button 102 may be present on the wearable device 100 for purposes of allowing a user to control certain features such as recording, turning on or off, or capturing a photo. Various control applications of a button 102 could be used in a variety of different fashions, with certain sequences of button presses being interpreted by a processor to mean different control commands. The rear right view in FIG. 1D illustrates one embodiment of the invention with waterproof and shock resistant housings 104 located on the ear-pieces of the wearable device 100 that may contain a processing unit, power source, a wireless transmitter, or any other necessary components.

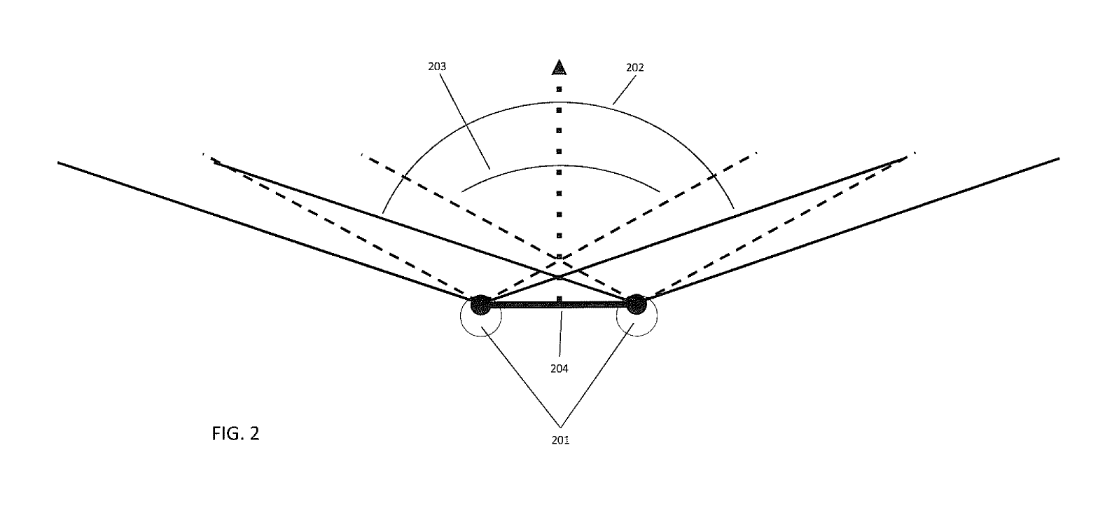

FIG. 2 demonstrates the horizontal projection of the field of views and resulting regions of binocular redundancy 202 of an example embodiment of the present invention compared to the average human eye. The angle that defines the region of binocular redundancy 203 for the average human eye 201 is about 120°, shown by the dotted lines subtending from the white circle depicting the user's eye. The left and right imaging components, depicted in the simplified diagram 204 as black circles connected by a line with a dotted arrow that is a vector representation of the direction parallel to the optical axes of the left and right imaging components 101. In many implementations of the invention, the wide fields of view of the lens apparatuses on the left and right imaging components, depicted as solid lines subtending from the diagram of the previously described imaging components 204 results in region of binocular redundancy 202 defined by an angle wider than the approximate region of binocular redundancy for humans. Any implementations of the invention utilizing lenses with larger fields of view will increase this angle. This larger region of binocular redundancy 202 allows for the content to be displayed in a virtual reality headset in a way that allows the user to look around within the recorded scenery in a panoramic fashion enabled by virtual reality displays and for stereoscopy to take place, resulting in the brain interpreting the scenery as being in three dimensions.

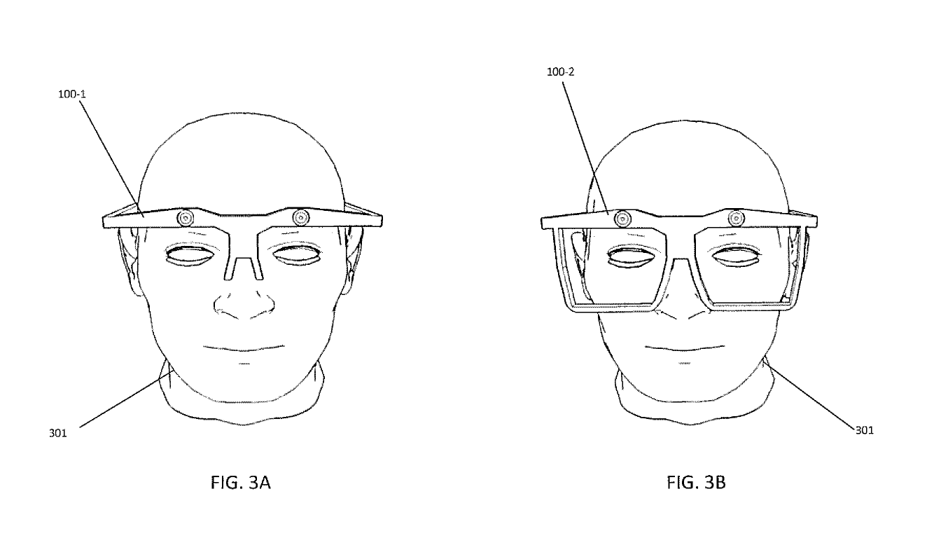

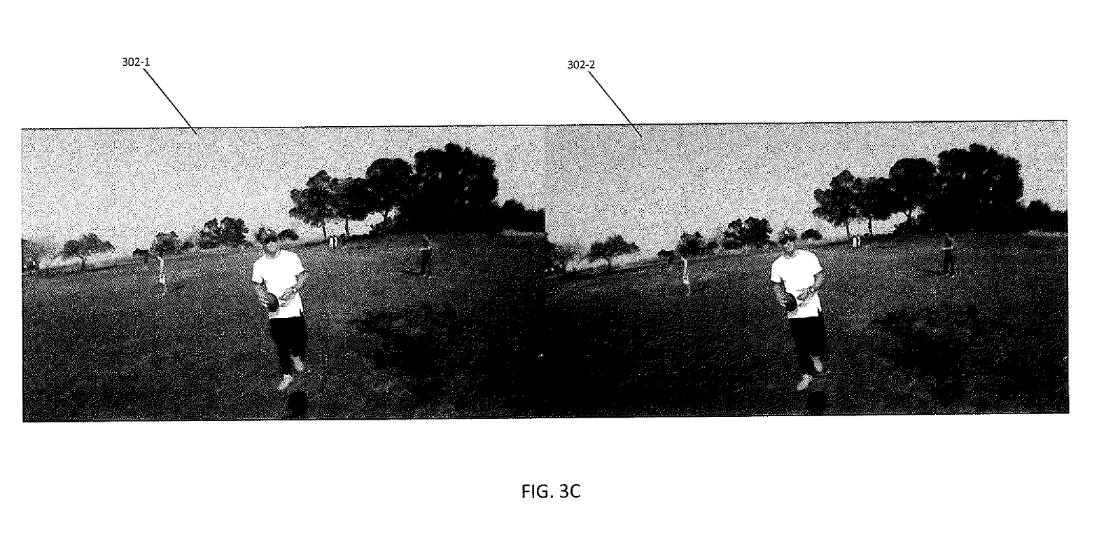

FIGS. 3A-3B each shows how different embodiments of the wearable device 100, one with glasses frames 100-2 and one without 100-1, are worn to perform stereoscopic, binaural, and inertial recording from the user's 301 precise first person perspective. This allows the user 301 to broadcast a virtual rendition of their experiences through any number of immersive digital media environments such as virtual reality. The above embodiments are shown as examples and should not be seen in a limiting manner. Other embodiments such as goggles or the like may be used without departing from the spirit and scope of the present invention. One operational mechanism for this embodiment of the invention 100 is performed by control inputs from an external computing device, commonly a smartphone or tablet, wirelessly networked to the invention.

FIG. 3C demonstrates one implementation of the invention of which the format of the camera output may be such that the left and right hand images 302 captured by the corresponding imaging components 101 are concatenated to each other side by side. When presented through a virtual reality display or any other type of 3D display, the left and right hand images 302 are each isolated to the respective eye and stereoscopy takes place which causes the brain to interpret three-dimensional depth inside the region of binocular redundancy 202 of the two imaging components 101.

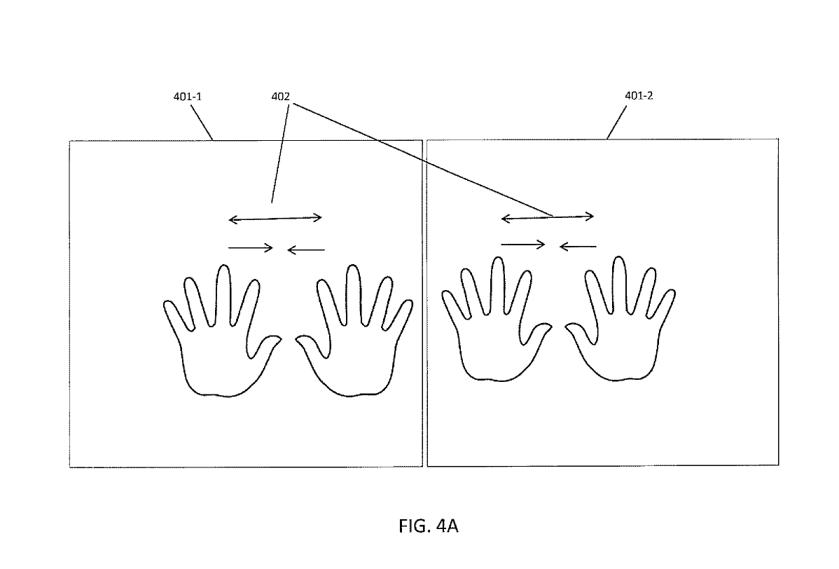

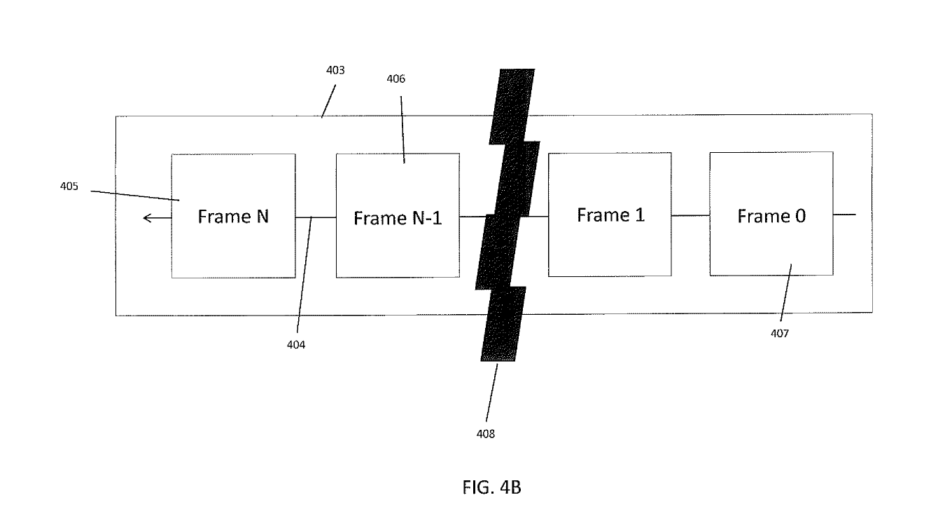

FIG. 4A shows one example of how the user controls this embodiment of the invention by performing previously programmed gestures 402 associated with operational functions, with respect to the imaged region 401 of the left and right imaging components 101 of the wearable device 100.

An embodiment of the present invention may be capable of being programmed to detect gestures used as operational inputs for the wearable device 100. This is done by initializing a “program gesture mode” through either a tactile button press, voice command, or command from a tethered device; performing a gesture or sequence of gestures, and declaring a desired operation to be associated with the gesture.

The programmed hand gestures 402 are performed in front of at least one of the cameras and the image data from the duration of the gesture is analyzed by the processor and serves as a control input. In this example, upon detecting both hands laterally oscillating, the processing unit may execute an operation associated with this gesture 402.

In one implementation of the invention the gesture recognition is enabled by a passively recording buffer mode. FIG. 4B depicts a buffer 403 that iterates through a sequence of frames 404. In this implementation of the invention, the device begins writing a stream of frames to temporary memory. These frames may be down-sampled and captured at a smaller frame rate than when otherwise recording with the camera. As the buffer fills up, the oldest frame 405 is erased from local memory as the newest frame 407 enters the sequence. The large central separating element 408 should be interpreted as an unknown amount of additional frames existing within buffer 403, where the last 405 and second to last 406 frames of the buffer are depicted to its left. This buffer sequence may hold as many frames as permitted by the on-board memory storage unit, but a reasonable implementation may range from 1 to 10 seconds of frames sampled at 15 frames per second. In this implementation of the invention, multi-step gestures may be identified, interpreted, and executed.

In another such implementation, the buffer sequence 403 may be used otherwise to enhance the practical utilities and capabilities of the wearable device 101. For instance, in one such implementation, the buffer sequence 403 may be saved in its entirety to record events that occur unexpectedly that the user may not be able to respond in time to begin recording. For example, the user may encounter a car with five wheels driving down the road and by the time they realize what they saw, the car is already gone. The user may issue a command to the wearable device 101, through any previously described input, that saves all the frames in the buffer sequence and begins recording at full resolution and frame rate from then on. The downsampled frames saved during the buffer sequence 403 are cropped before the normally sampled frames, resulting in a full-length video throughout the duration of the event.

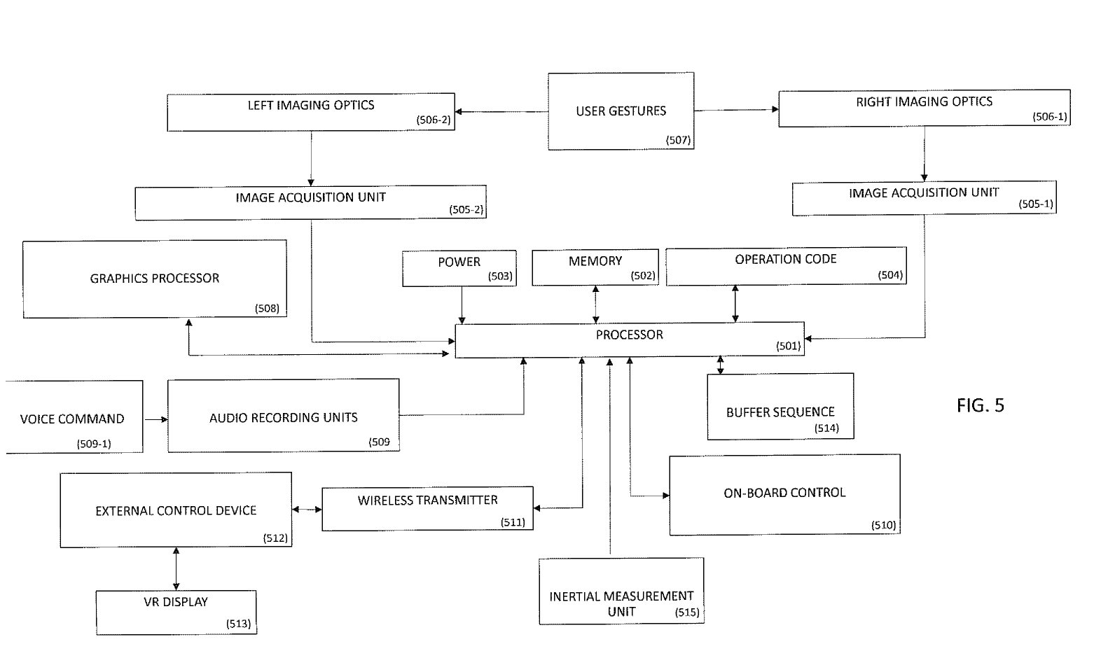

FIG. 5. shows a functional block diagram of the operational circuitry for one embodiment of the invention. The left 506-2 and right 506-1 imaging optics apparatuses each contain a lens and lens mount which positions the lens in a fixed focus upon the image sensor. The image sensor is the input of the image acquisition units 505 which output image data, in any image or video format, through a camera serial interface, or other such interface, to a processor unit 501. The audio recording units 509 gather audio data, which is processed by the processor 501 to achieve binaural sound upon output. The embodiment of the present invention currently described is controlled by a combination of on-board controls 510, controls from an external device 512, and gesture based controls 507 that may be detected and interpreted by an on-board graphics processor 508 that functionally acts on frames stored in the buffer sequence 514 previously described. In one embodiment of the present invention, the on-board control 510 consists of a single button, which is used to power on and off the device in addition to establishing a wireless network connection (e.g. via WiFi, Bluetooth, or a cellular network) with the external control device 512 by means of a wireless transmitter 511. The external control device 512 will provide the user the ability to operate the wearable device 100, assess recorded data, and format the recorded data in manner such that it can be viewed through a virtual reality display 513.

The wearable device of the present invention will also be equipped with a power unit 503, a memory component 502, inertial measurement unit 515, and operation code 504. The operation code 504 should be understood to be any such embodiment of software or hardware required by the processor 501 in order to accomplish its tasks and exercise full functionality with respect to the present invention. The memory device 502 may include, for example, one or more volatile and/or non-volatile memories. In other words, for example, the memory device 502 may be an electronic storage device (e.g., a computer readable storage medium) comprising gates configured to store data (e.g., bits) that may be retrievable by a machine (e.g., a computing device). The memory device 502 may be configured to store information, data, applications, instructions or the like for enabling the apparatus to carry out various functions in accordance with example embodiments of the present invention. For example, the memory device 502 could be configured to buffer input data for processing by the processor 501. Additionally, or alternatively, the memory device 502 could be configured to store instructions for execution by the processor 501.

The processor 501 may be embodied in a number of different ways. For example, the processor 501 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 501 may be configured to execute instructions stored in the memory device 502 or otherwise accessible to the processor 501. Alternatively, or additionally, the processor 501 may be configured to execute hard coded functionality. As such, whether configured by hardware or software methods, or by a combination thereof, the processor 501 may represent an entity (e.g., physically embodied in circuitry) capable of performing operations according to embodiments of the present invention while configured accordingly. Thus, for example, when the processor 501 is embodied as an ASIC, FPGA or the like, the processor 501 may be specifically configured hardware for conducting the operations described herein. Alternatively, as another example, when the processor 501 is embodied as an executor of software instructions, the instructions may specifically configure the processor 501 to perform the algorithms and/or operations necessary for the wearable device to function successfully and as intended. However, in some cases, the processor 501 may be a processor of a specific device (e.g., an eNB, AP or other network device) adapted for employing embodiments of the present invention, and may entail further configuration of the processor 501. The processor 501 may include, among other things, a clock, an arithmetic logic unit (ALU) and logic gates configured to support operation of the processor 501.

Meanwhile, the wireless transmitter 511 may be any means such as a device or circuitry embodied in either hardware, software, or a combination of hardware and software that is configured to receive and/or transmit data from/to an external control device 512 and/or any other device or module in communication with the apparatus. In this regard, the wireless transmitter 511 may include, for example, an antenna (or multiple antennas) and supporting hardware and/or software for enabling communications with a separate external control device 512 or similar computing device. In some environments, the wireless transmitter 511 may alternatively or also support wired communication. As such, for example, the wireless transmitter 511 may include a communication modem and/or other hardware/software for supporting communication via cable, digital subscriber line (DSL), universal serial bus (USB) or other mechanisms.

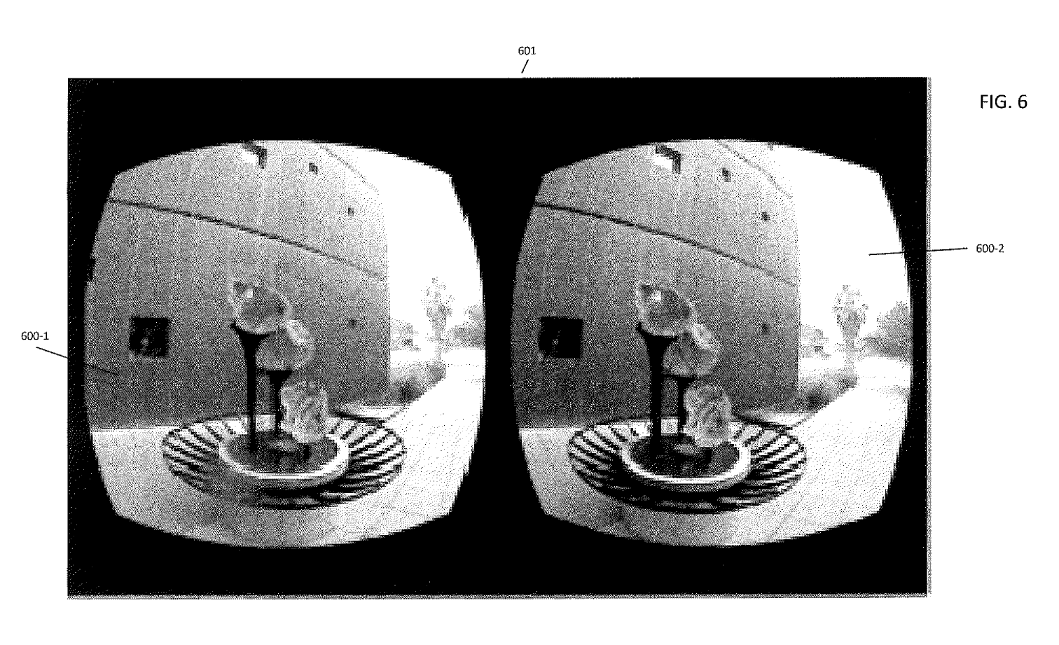

FIG. 6 shows an example of how the content recorded by the previously described embodiment of the present invention may be displayed and navigated within a virtual reality headset. The data acquired through the left image acquisition unit is displayed on the left 600-1 and likewise for the right side 600-2. When looking into a virtual reality display, the left and right images are isolated to their respective eyes. The region of the image displayed to the viewer depicted by the rounded square viewports 601 is dependent on the position and orientation of the user's head when viewing the content through a virtual reality display. The inertial measurement units native to the virtual reality device are used to detect changes in viewing direction and respond accordingly by changing the region that is displayed within the viewports 601.

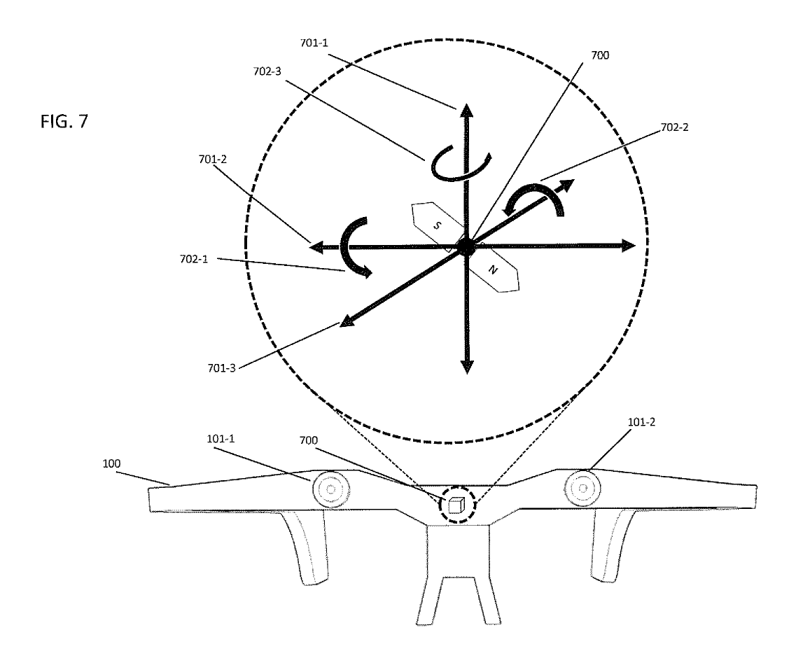

FIG. 7. shows an example embodiment of the present invention, in which the wearable device 100 similar to that of any previously described embodiments and implementations is configured such that an inertial measurement unit 700, which may be embodied as a gyroscope, accelerometer, magnetometer, or any such combination of these or other motion sensitive electronic devices, is used in conjunction with the left and right imaging components 101 that compose the stereoscopic camera. The wearable device 100 of the present invention is shown from a front perspective, indicating one possible location of the inertial measurement unit 700 embedded inside the device. The inertial measurement unit 700 detects and records linear movement 701 and rotationally 702 the three spatial axes. Additionally, a magnetometer 703 may be used to record the orientation of the device 100 relative to the magnetic field of the earth or any other planet or interstellar body. Data describing the motion about this point in between the two cameras is used to compute the motion of each individual camera module 101. Adequate feature detection processes and proper calibration of the stereo imaging system of the wearable device 100 functionally relate linear 701 and angular 702 motion to the resulting change in the region imaged in 3D 202. This implementation of the invention mimics the manner in which the human brain understands the space around itself and is applicable to augmented reality applications in which such an implementation is required to gather information about the user's surroundings to overlay digital objects. Leveraging the relationship between camera movement and angular projection of 3D features imaged by the stereo camera 101 is useful in alleviating the computational burden of achieving spatial awareness on implementations of the invention embodied by space constrained, low-latency augmented reality devices. Additionally, data collected by this embodiment of the motion detection sensor 700 may be used to enhance the photographic capabilities of the device. For example, in one such implementation in which the user is taking a still 3D photo, the device 100 may capture a stream of still frames and only save the frame when the device is sufficiently stationary and level to the ground, characteristics valued by those skilled in the art of 3D photography. Another such use case of this implementation may detect if a 3D video is too shaky, relative to either a predefined or user-generated threshold, to be comfortably viewed in virtual reality without feeling motion-sickness that is sometimes felt by users of virtual reality. Additionally, this implementation may be utilized to provide video stabilization by detecting and computationally offsetting the angular rotation of the camera.

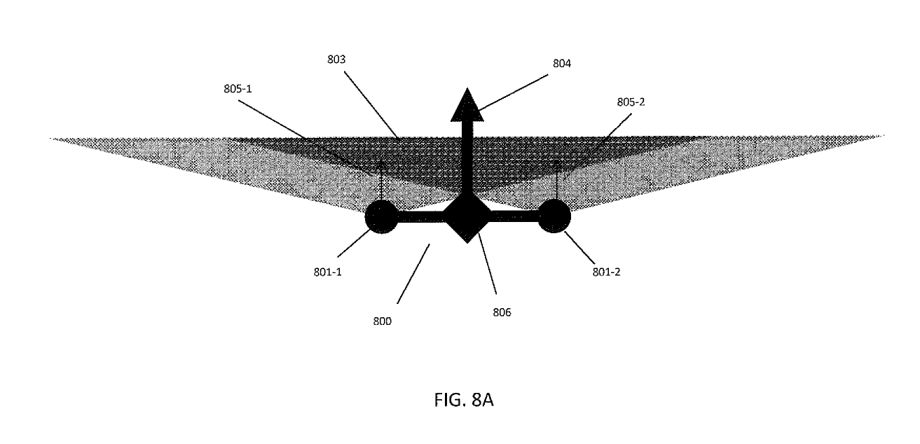

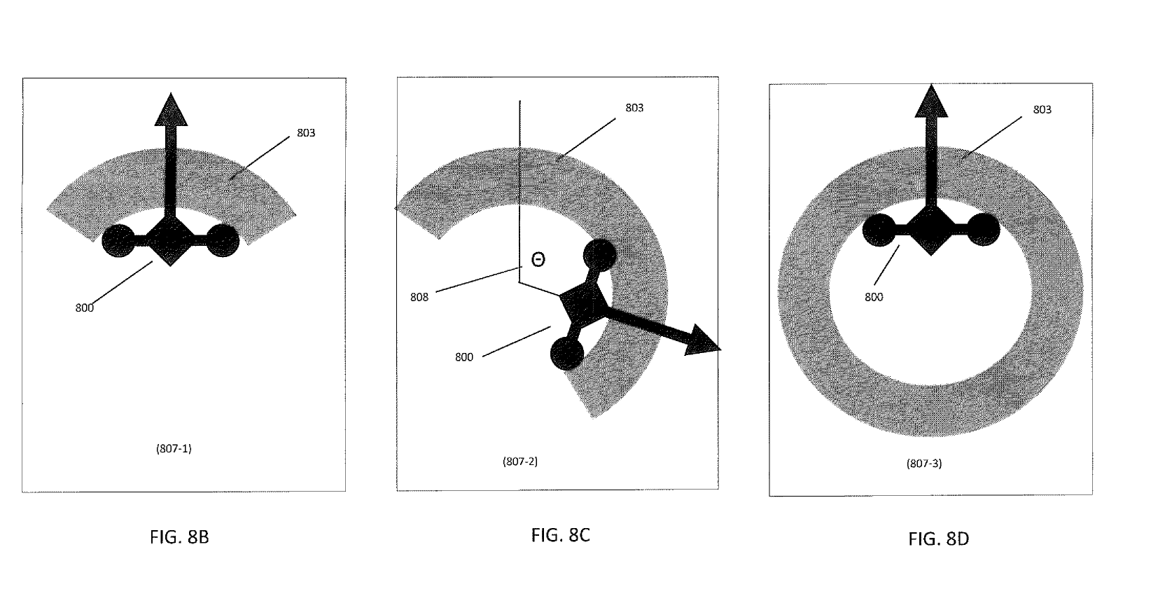

FIGS. 8A-8D demonstrates implementations of the invention in which the previously described inertial measurement unit is leveraged in conjunction with a trained user interaction in order to collect images that may be stitched together in such a way to produce a panoramic, stereoscopic image with horizontal and vertical fields of view that subtend an area larger than the inherent fields of view of the individual camera lenses. FIG. 8A is a top view of a simplified representation 800 of one such implementation of the invention composed of two cameras 101, symbolized by the connected circular dots 801, with fields of view 802 depicted in light grey, and regions of binocular redundancy 803, as previously described, depicted in dark gray. The arrow 804 pointing perpendicular to the line connecting the circular dots 801 is a vector representation of the device orientation direction, defined as the direction along the optical axes 805 of the components of the stereoscopic camera 101 embodied in the wearable device 100, which may be tracked by the inertial measurement unit 806 previously described.

The user starts the panoramic, stereoscopic capture process 807 by initializing the feature through any previously described, or implied, control mechanism, which begins the collection of a stream of image frames and motion data. The user then stands in place and looks around the scenery by spinning their body around and/or rotating their head from side to side or up and down in order to scan the area they wish to capture. FIG. 8B-8D depicts the simplified representation of the wearable device 800 and a representation of the region of stereoscopic binocular redundancy 803 that is captured during three stages of the panoramic scanning process 807 before rotation 807-1, mid-rotation 807-2, and after full rotation 807-3. As depicted, this process may be terminated at any point, resulting in a stream of images and motion data that may be used to create a panoramic 3D image with a field of view dependent on the angular subtense 808 of the scanning motion the user employs during the panoramic scanning process 807. A complete rotation gathers enough information to create a full 360-degree, stereoscopic, panoramic image. In a post-production process performed either on the device 100 or any previously described computing unit, the image frames are stitched together such that the resulting output is two images, corresponding to the left and right eye, spanning the entire region scanned by the user which are then rendered, as spheres or portions of spheres, and displayed to the corresponding eye within a virtual reality environment. Another use-case of this implementation in which the motion of the camera is functionally related to the angular location of the corresponding image frames may be utilized as a mechanism to enhance presence by matching the location of the rendered frame in the virtual reality environment to the relative angular direction the user is facing during the duration of that particular frame and dynamically updating the rendered location upon each successive frame.

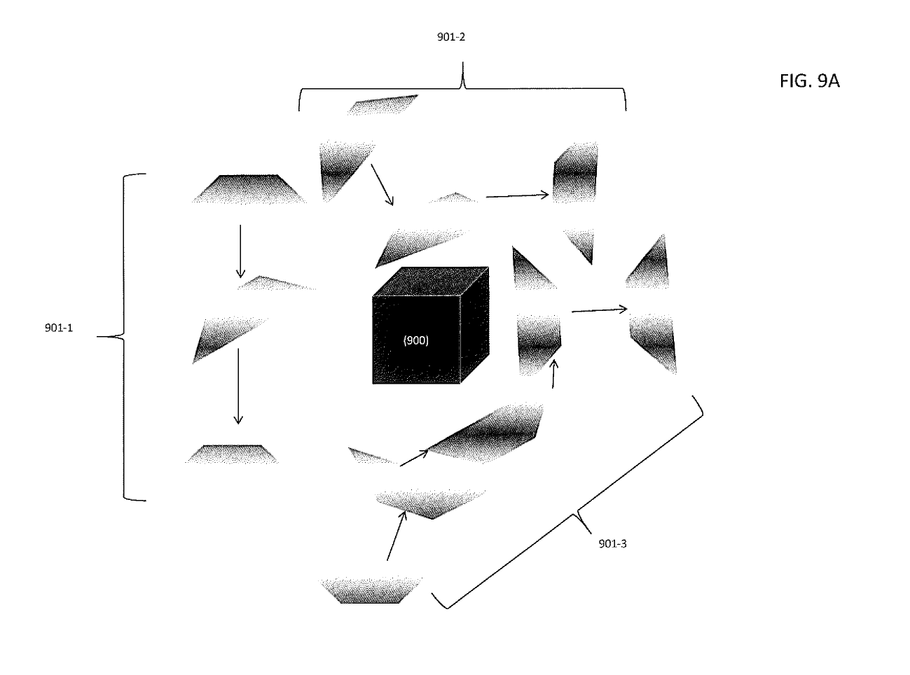

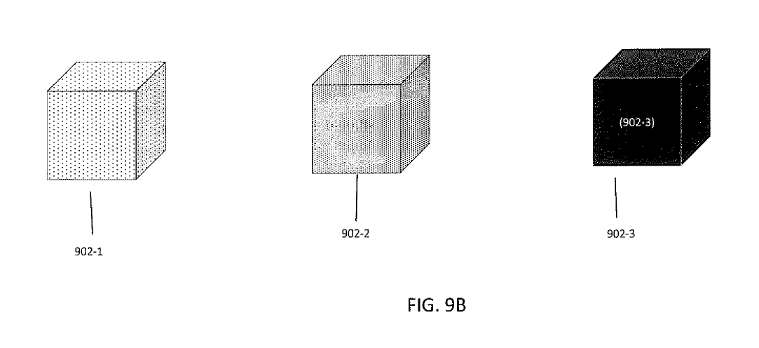

FIG. 9A-9B demonstrates one implementation of the invention in which any number of wearable devices 100 being independently operated compose a distributed network of camera nodes that collectively gather 3D spatial information. This information may be aggregated and used to reconstruct photogrammetric point cloud renditions of locations and objects. The photogrammetric renditions created using this implementation of the invention may achieve high degrees of spatial resolution due to the inherent binocular redundancy of this embodiment of the invention as previously described. The spatial resolution is further enhanced with increasing number of images from different vantage points with redundant regions that are collected as more users of the wearable device record 3D images. For example, In the context of the present invention proposed, FIG. 9A shows an object 900 that users of the wearable device 100 take varied levels of interest in 901. Depicted are three such interest levels 901 where users barely care 901-1 and glance as they walk by the object 900, others casually inspect before moving on 901-2, and some take such keen interest 901-3 that they capture a video using the wearable device 100 so they may either rewatch at a later time or share to others to watch in 3D virtual reality. After the first person using this implementation of the invention captures it in their field of view, the 3D photogrammetric rendition of the landmark may begin to take shape. As more people also using the wearable device 100 walk by and deliberately record high quality videos while other users of the wearable device 100 passively capture images of the object 900 as part of the buffer sequence as previously described, the photogrammetric rendition of the object 900 may achieve higher and higher resolutions over time 902, as depicted in FIG. 9B. Over a sufficient period of time, and bolstered with other means of computing of volumetric point cloud information including, but not limited to LIDAR, infrared scanners, or otherwise, a hyper-resolute point-cloud 902-3 of this object 900 may form.

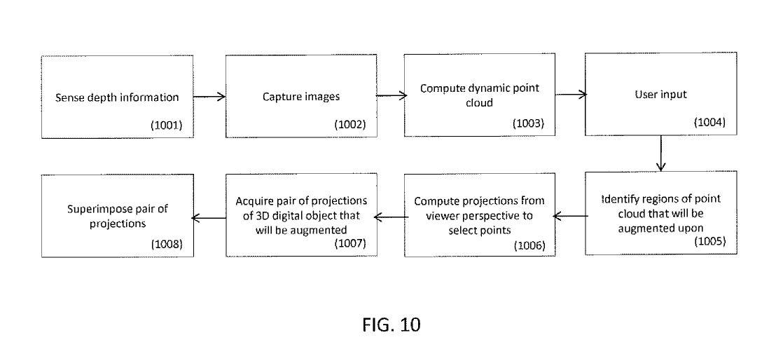

FIG. 10 shows one implementation of the invention in which the stereo camera apparatus 100 and the inertial measurement unit 700 are leveraged in order to calculate depth information that may be used to superimpose a 3D object within the 3D image that becomes apparent when the image is viewed in virtual reality. FIG. 10 shows the process 1000 how this implementation of the invention is executed either on the device or via an external computing unit, and how the image is displayed such that the 3D augmented object appears within the image. In the best implementation of the invention, the passive buffer sequence 403 as previously described is initiated and begins sensing depth information 1001 about the surroundings. Next, the user initializes the camera and begins recording a stream of stereoscopic image frames of the desired scenery 1002. This video may be streamed to an external computing device in real time or saved to on-board memory and sent at a later time. Either on the device or on an external computing unit, a 3D spatial profile of the video is computed resulting in a three-dimensional point cloud representation of the video 1003. Using this spatial information, the depth at which a digital object is to be augmented within the scenery, as inputted by the user 1004 through any previously described methods, is used to identify and index 1005 any collection of points within the point cloud upon which a digital object will be placed. The distance information about this collection of points may then be used to algorithmically generate the appropriate projections 1006 of the 3D digital entity that may be superimposed within the image collected by the stereoscopic imaging device. In order to create these projections, a three-dimensional representation of the desired object to be augmented must be built by any means that those experienced in the art of 3D animation or computer aided design may be familiar. Next, a series of projections of the object are captured from vantage points matching the distance, orientation, and relative location that the digital object must appear from the perspective of the viewer 1007. Per frame, two projections are captured of the object, resulting in two images of the same object from the perspective of the camera device that captured the image such that when they are superimposed 1008 within the object and then viewed in a 3D virtual reality environment, they appear to be naturally within the image. In many implementations of the proposed invention, sensing spatial information to compute projections of objects to be augmented within the captured image may be used to support an augmented reality, smart-glasses device. Unlike the implementation where the projections are superimposed within images that are viewed in VR, the projections are displayed directly to the user through a transparent or semi-transparent display that gives the illusion that the digital object is present in reality.

The foregoing description is illustrative of particular embodiments of the invention, but is not meant to be a limitation upon the practice thereof. The following claims, including all equivalents thereof, are intended to define the scope of the invention.

What is claimed is:

1. A pair of smart-glasses comprising:
a frame;
a pair of camera units positioned on a front area of the frame and separated laterally a distance comparable to that of adult human eyes;
a binaural microphone system coupled to the frame to mimic human ears; and
inertial measurement units coupled to the frame that simulate the human vestibular system.

1. mart-glasses of claim 1, wherein the smart-glasses collect high-definition stereoscopic images, binaural audio, and spatial orientation information in order to render pictures and videos that appear in 3D when viewed in a virtual reality, augmented reality, or other type of immersive digital environment.

3. The smart-glasses of claim 1, wherein the smart-glasses process stereoscopic image data and inertial motion data in conjunction with one another to dynamically compute three-dimensional spatial information of the user's surroundings.

4. The smart-glasses of claim 1, comprising a power source to power the smart-glasses, wherein the smart-glasses emits and receives wireless signals to be networked to other computing devices.

5. The smart-glasses of claim 1, wherein the smart-glasses is controlled wirelessly from at least one of tethered devices, control buttons, tactile sensors, or computationally by processing user gestures detected by the imaging components.
